(19) United States
(12) Patent Application Publication
(10) Pub. No.: US 2012/0166301 A1
(43) Pub. Date: Jun. 28, 2012

(54) ONLINE TRANSACTION METHOD AND ONLINE TRANSACTION SYSTEM

(76) Inventor: Bruce CHEN, Taipei (TW)

(21) Appl. No.: 13/335,269

(22) Filed: Dec. 22, 2011

Related U.S. Application Data
(60) Provisional application No. 61/459,999, filed on Dec. 23, 2010.

(51) Int. Cl. G06Q 30/08

(52) U.S. Cl. 705/26.3

(57) ABSTRACT

An online transaction method includes providing a network platform, providing a seller interface and providing a buyer interface. The seller interface is stored in the network platform for the sellers to set commodity data, selling price, quantity per unit and selling condition of at least one commodity. The selling price per unit is obtained from the result of dividing the selling price by the amount per unit. The selling condition includes the selling duration and minimal sell quantity per unit. The buyer interface is stored in the network platform for the buyers to connect for choosing the number of the corresponding units of to-buy commodity. When the number of the unit of the commodity is higher than or equal to the minimal sell quantity and the set selling duration ends, the bidding winner will be selected from those who purchase that unit of commodity.

### BACKGROUND OF THE INVENTION

1. Field of the Invention

The present invention relates to an online transaction method and a system for the same.

2. Description of Related Art

Due to the advantages of popularity and convenience, the Internet has no time and space constraints. No significant rental or labors needs for running business in online shop, like in a physical store. Therefore it benefits low cost. As a result, the application of the Internet makes e-commerce rapidly developing.

Among them, the use of a network platform to provide consumers to transact online has been changing people's consumption habits. When the consumers enter the shopping websites, they can directly click the product and pay through a variety of payment method without any time and space constraints.

Currently, the shopping patterns used by shopping websites broadly include two categories: competitive bidding mode and general shopping mode. In the competitive bidding mode, the potential buyers give their commercial values on the commodity, and finally the one who gives the highest commercial value among others will be the bidding winner after a certain period of time. In the general shopping mode in which each product has a fixed price, when buyers decide to purchase, they directly pay online to complete the buying action just like they do in the physical stores.

However, the disadvantages of the above shopping are as follows:

1. The buyers must pay the amount equal to the relative value of commodity they buy. Either in bidding mode or general shopping mode, the price must reach to the value the sellers set. If the buyers cannot afford it, then they will have no chance to get.

2. There is a room for cheating in the bidding mode in which the one who gives highest price among others will win the bidding. The bid results are easy to infer by the other fraud accounts.

3. The general shopping model is more rigid. This mode is the usual shopping pattern of daily life. The only difference from the physical shop is to change the location for the display of commodity. Therefore, it seems boring in the process of buying.

Therefore, there is a need of an online transaction method and a system for the same which overcomes the above disadvantages.

### SUMMARY OF THE INVENTION

The object of the present invention is to provide an online transaction method and a system for the same. It needn't to pay the amount equal to the relative value of the commodity, and it has no chance to cheat while adding more to online shopping.

In order to achieve the above and other objectives, the online transaction method of the present invention includes providing a network platform, providing a seller interface and providing a buyer interface. A plurality of sellers and a plurality of buyers are networked via the network platform. The seller interface is stored in the network platform for the sellers to set commodity data, selling price, quantity per unit and selling condition of at least one commodity. The selling price per unit is obtained from the result of dividing the selling price by the amount per unit. The selling condition includes the selling duration and minimal sell quantity per unit. The buyer interface is stored in the network platform for the buyers to connect for choosing the number of the corresponding units of to-buy commodity. When the number of the unit of the commodity is higher than or equal to the minimal sell quantity and the set selling duration ends, the bidding winner will be selected from those who purchase that unit of commodity.

By the above method, the buyer can buy units with fewer budges while less damage to the seller's benefit. Meanwhile, randomly selecting the bidding winner will not suffer the cheating fraud but adds a bit of tension and entertainment effect.

Preferably, the online transaction method according to the present invention further provides a competing interface through which the buyers who purchase that unit of commodity competes with one another via games and one of them will be the bidding winner.

The online transaction method of claim 1, wherein when the set selling duration ends, and the number of sold units is less than the minimal sell quantity, then no winner cannot be selected.

Preferably, the online transaction method according to the present invention prevents the selling price goes to the lowest one in order to maintain the seller's interest.

In another aspect of the invention, an online transaction system is provided to implement the above method, so that more fun can be added, cheating can be prevented and more good chances to buy commodity at profitable prices can be offered in such an online transaction platform.

In order to further the understanding regarding the present invention, the following embodiments are provided along with illustrations to facilitate the disclosure of the present invention.

### BRIEF DESCRIPTION OF THE DRAWINGS

FIG. 1 is a schematic flow chart of an online transaction method according to one embodiment of the invention.

FIG. 2 is a block diagram of an online transaction system according to one embodiment of the invention.

FIG. 3 is a schematic view of operation of an online transaction system according to one embodiment of the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

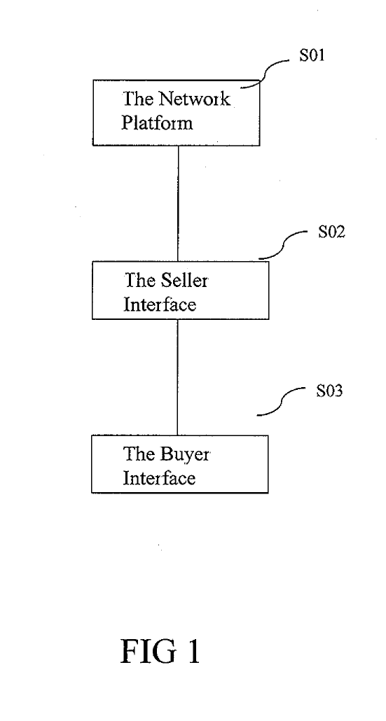

Referring to FIG. 1, an online transaction method according to the present invention includes providing a networking platform S01, providing a seller interface SO2 and providing a buyer interface S03. The contents of these three steps are further described as follows.

Providing a network platform S01: A plurality of sellers and a plurality of buyers are networked via the network platform.

Providing a seller interface S02: The seller interface SO2 is stored in the network platform for the sellers to set commodity data, selling price, quantity per unit and selling condition of at least one commodity. The selling price per unit is obtained from the result of dividing the selling price by the amount per unit. The selling condition includes the selling duration and minimal sell quantity per unit.

Providing a buyer interface S03: The buyer interface is stored in the network platform and provided for the buyers to connect for choosing the number of the corresponding unit of the to-buy commodity.

When the number of the unit of the commodity is higher than or equal to the minimal sell quantity and the set selling duration ends, the bidding winner will be selected from those who purchase that unit of commodity. It is allowed that the same buyer purchases a plurality of the same commodity so as to increase the chance to win.

By the above method, the buyer can buy one or more units with fewer budges. Meanwhile, becoming the bidder needn't pay the whole original cost, thus reducing the purchase threshold without losing the interest of the seller. Additionally, determining the winning bidder by setting how the network platform works (for example, random) will has no question of fraud such as driving up the selling price, but offers entertainment effect. Therefore, the method according to the present invention has several effects which conventional online bidding systems cannot offer.

Furthermore, the method according to the present invention offers a competing interface through which the buyers who purchase that unit of commodity competes with one another and one of them will be the bidding winner.

If the set selling duration ends, and the number of sold units is less than the minimal sell quantity, then no winner cannot be selected. In such case, the seller can reset the corresponding unit of the to-sell commodity or cancel the selling deal.

The selling condition further includes a predetermined opening time for purchase and a predetermined closed time for purchase, by both of which the selling duration can be set (the time starts to buy and the time ends buying) so as to cope with the seller for advertising in advance or various publicity before the predetermined time point, increasing the ease of operation. The probability of winning can be shown after the buyer has purchased that unit of commodity, adding more motivation to the buyers to purchase more units.

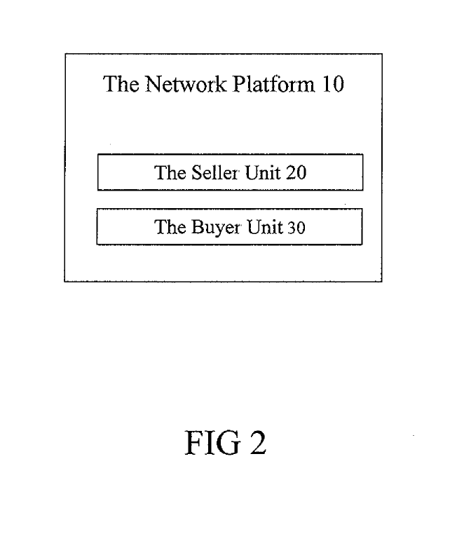

Referring g to FIG. 2, an online transaction system for the above method includes a network platform 10, a seller unit 20 and a buyer unit 30. The network platform 10 works for sellers and buyers to connect to one another. The seller unit 20 is stored in the network platform 10 for the sellers to set commodity data, selling price, quantity per unit and selling condition of at least one commodity. The selling price per unit is obtained from the result of dividing the selling price by the amount per unit. The selling condition includes the selling duration and minimal sell quantity per unit. The buyer unit 30 is stored in the network platform 10 and provided for the buyers to connect for choosing the number of the corresponding unit of the to-buy commodity. When the number of the unit of the commodity is higher than or equal to the minimal sell quantity and the set selling duration ends, the bidding winner will be selected from those who purchase that unit of commodity.

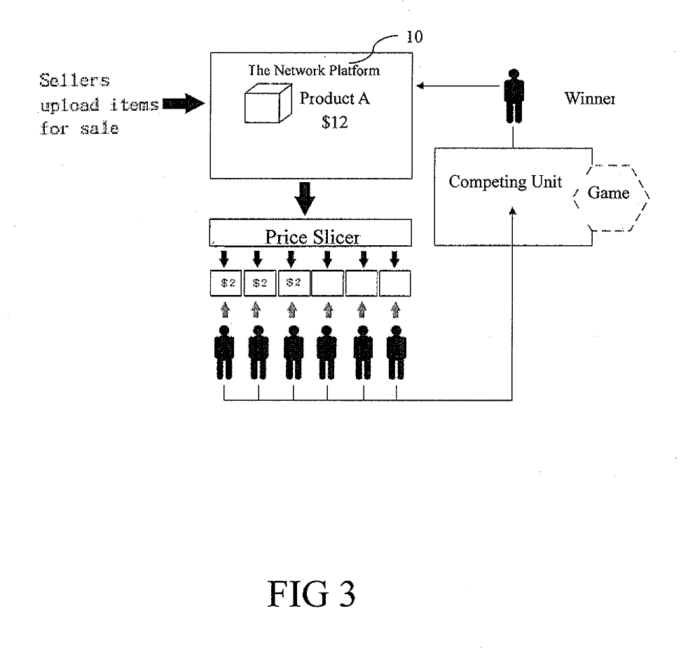

With the use of the above system, the effect of the above method can be achieved. The implementation of the overall process according to the present invention will be illustrated with the reference of FIG. 3. Initially, the seller uploads the information of the to-sell commodity into the network platform 10 through the seller unit, and then sets the number of unit and calculates the selling price per unit. For example, if the price of the commodity is 12 dollars and would be divided into 6 units, then the selling price per unit is 2 dollars. When all the units have been sold out, a winner will be selected from those who have purchased the commodity via a game or randomly by a competing unit as the bidding winner. Thereby, it will offer more fun in online shopping while overcoming the disadvantages in conventional shopping web site.

Furthermore, when the set selling duration ends, and the number of sold units is less than the minimal sell quantity, no winner cannot be selected. The seller can reset the corresponding unit of the to-sell commodity or cancel the selling deal.

The selling condition further includes a predetermined opening time for purchase and a predetermined closed time for purchase, thereby increasing the ease of trading.

Button setting can be further provided for the seller unit for the seller to put in various options so as to generate corresponding options to the website the buyers are surfing. Feedback proportion or payment mechanism can be further set as charge standard for the platform. For example, a commodity cost is further set so that when the commodity is sold out, the system will directly calculate the profit, and then deduct a certain percentage of the profit such as 5% as the service fee of the system. Alternately, the service fee will calculated on the basis of use load. The service fee can be one of the income sources.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A n online transaction method, comprising:
providing a network platform, via which a plurality of sellers and a plurality of buyers are networked;
providing a seller interface, stored in the network platform for the sellers to set commodity data, selling price, quantity per unit and selling condition of at least one commodity, wherein the selling price per unit is obtained from the result of dividing the selling price by the amount per unit, and the selling condition includes the selling duration and minimal sell quantity per unit;
providing a buyer interface, stored in the network platform for the buyers to connect for choosing the number of the corresponding units of to-buy commodity;
when the number of the unit of the commodity is higher than or equal to the minimal sell quantity and the set selling duration ends, the bidding winner will be selected from those who purchase that unit of commodity.

2. The online transaction method of claim 1, further comprising a competing interface through which the buyers who purchase that unit of commodity competes with one another and one of them will be the bidding winner.

3. The online transaction method of claim 1, wherein when the set selling duration ends, and the number of sold units is less than the minimal sell quantity, then no winner cannot be selected.

4. The online transaction method of claim 1, wherein the selling condition includes a predetermined opening time for purchase and a predetermined closed time for purchase.

5. An online transaction system, comprising:
a network platform, via which sellers and buyers connect to one another;
a seller unit, stored in the network platform for the sellers to set commodity data, selling price, quantity per unit and selling condition of at least one commodity, wherein the selling price per unit is obtained from the result of dividing the selling price by the amount per unit, and the selling condition includes the selling duration and minimal sell quantity per unit; and
a buyer unit, stored in the network platform for the buyers to connect for choosing the number of the corresponding unit of the to-buy commodity;
when the number of the unit of the commodity is higher than or equal to the minimal sell quantity and the set selling duration ends, the bidding winner will be selected from those who purchase that unit of commodity.

6. The system of claim 5, further comprising a competing unit in which those buyers who have purchased that unit of commodity compete with one another, and then one of them will be selected as the bidding winner.

7. The system of claim 5, wherein when the set selling duration ends and the number of sold units is less than the minimal sell quantity, no winner is selected.

8. The system of claim 5, wherein the selling condition includes a predetermined opening time for purchase and a predetermined closed time for purchase.
